(19) United States
(12) Patent Application Publication
(10) Pub. No.: US 2026/0091557 A1
(43) Pub. Date: Apr. 2, 2026

(54) THREE DIMENSIONAL SHAPED OBJECT MANUFACTURING METHOD

(71) Applicant: SEIKO EPSON CORPORATION, Tokyo (JP)

(72) Inventor: Satoshi YAMAZAKI, MATSUMOTO-SHI (JP)

(21) Appl. No.: 19/343,378

(22) Filed: Sep. 29, 2025

(30) Foreign Application Priority Data
Sep. 30, 2024 (JP) 2024-169915

(51) Int. Cl. B29C 64/393; B29C 64/106; B33Y 10/00; B33Y 50/02

(52) U.S. Cl. CPC B29C 64/393; B29C 64/106; B33Y 10/00; B33Y 50/02

(57) ABSTRACT

A three dimensional shaped object manufacturing method includes acquiring shape data representing a three dimensional shape, generating, based on the shape data, first shaping path data including first path information according to a first condition, determining whether a gap region is present in the first shaping path data, when the gap region is present, generating second shaping path data including second path information representing a movement path for filling the gap region, the second shaping path data being generated according to a second condition, and shaping the three dimensional shaped object according to the first shaping path data when no gap region is present and according to the first and the second shaping path data when a gap region is present. The presence or absence of a gap region is determined based on a difference between the length of the inner path and the length of the outer path.

The present application is based on, and claims priority from JP Application Serial Number 2024-169915, filed September 30, 2024, the disclosure of which is hereby incorporated by reference herein in its entirety.

### BACKGROUND

### 1. Technical Field

The present disclosure relates to three dimensional shaped object manufacturing method.

### 2. Related Art

With regard to a three dimensional shaped object manufacturing method, JP-A 2009-525207 discloses a technique for producing a residual path that fills a void region in a build path for building up a layer of a three dimensional shaped object. In the technique of JP-A-2009-525207, an intermediate path for calculating the dimensions of a void region is generated in the void region, the dimensions of the void region are determined based on the generated intermediate path, and a residual path is generated based on the determined dimensions.

In the technique of JP-A-2000-050377, for example, when the shape of the void region is relatively complicated, the processing load increases for generating the intermediate path and for determining the dimension of the void region. Therefore, a technique for filling the void region more easily is desired.

### SUMMARY

According to an aspect of the present disclosure, a three dimensional shaped object manufacturing method is provided. This manufacturing method includes a first step of acquiring shape data representing a three dimensional shape of a three dimensional shaped object; a second step of generating, based on the acquired shape data, first shaping path data including first path information that represents a movement path along which an ejection section moves, the first shaping path data being generated according to a first condition regarding the movement path; a third step of determining whether or not a gap region is present in the first shaping path data; when the gap region is present, a fourth step of generating second shaping path data including second path information representing a movement path for filling the gap region, the second shaping path data being generated according to a second condition, which is different from the first condition; and a fifth step of shaping the three dimensional shaped object by ejecting the shaping material from the ejection section toward a stage and stacking layers according to the first shaping path data when the gap region is not present and according to the first shaping path data and the second shaping path data when the gap region is present. The first path information includes information representing an inner path that is a movement path that circles around, and information representing an outer path, the outer path being a movement path that circles around and that is located outward from the inner path. In the third step, the presence or absence of the gap region is determined based on a difference between a length of the inner path and a length of the outer path.

### BRIEF DESCRIPTION OF THE DRAWINGS

FIG. 1 is an explanatory diagram illustrating schematic configuration of a three dimensional shaping system according to a first embodiment.

FIG. 2 is a perspective view illustrating a schematic configuration of a lower surface side of a flat screw.

FIG. 3 is a schematic plan view illustrating an upper surface side of a barrel.

FIG. 4 is an explanatory diagram schematically illustrating a state in which a three dimensional shaping device shapes a shaped object.

FIG. 5 is an explanatory diagram of schematic configuration of an information processing device.

FIG. 6 is a flowchart of a shaping process in the first embodiment.

FIG. 7 is a diagram illustrating an example of first shaping path data.

FIG. 8 is a first diagram illustrating an example of a third step in the first embodiment.

FIG. 9 is a second diagram illustrating an example of the third step in the first embodiment.

FIG. 10 is a diagram illustrating an example of second shaping path data in the first embodiment.

FIG. 11 is a diagram illustrating an example of second shaping path data in a second embodiment.

FIG. 12 is a diagram illustrating an example of second shaping path data in a third embodiment.

FIG. 13 is a flowchart of a shaping process in a fourth embodiment.

FIG. 14 is a flowchart of a shaping process in a fifth embodiment.

FIG. 15 is a diagram illustrating an example of second shaping path data in a fifth embodiment.

### DESCRIPTION OF EMBODIMENTS

### A. FIRST EMBODIMENT

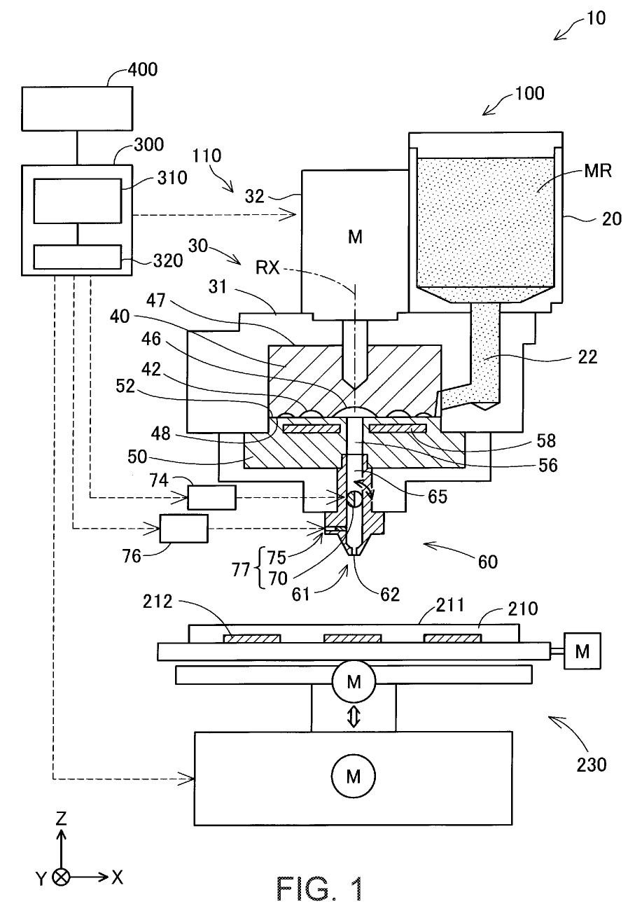

FIG. 1 is an explanatory diagram illustrating schematic configuration of a three dimensional shaping system 10 in a first embodiment. In FIG. 1, arrows indicating X, Y, and Z directions orthogonal to each other are illustrated. The X direction and the Y direction are directions parallel to a horizontal plane, and the Z direction is a direction along a vertically upward direction. The arrows indicating the X, Y, and Z directions are appropriately illustrated in other drawings so that the illustrated directions correspond to those in FIG. 1. In the following description, when a direction is specified, a direction indicated by an arrow in each drawing is referred to as "+" and an opposite direction is referred to as "-", and positive and negative signs are used in combination for direction notation. Hereinafter, the +Z direction is also referred to as "upper", and the -Z direction is also referred to as "lower".

The three dimensional shaping system 10 includes a three dimensional shaping device 100 and an information processing device 400. The three dimensional shaping device 100 of the present embodiment is a device that shapes a shaped object by a material extrusion method. The three dimensional shaping device 100 includes a control section 300 for controlling each section of the three dimensional shaping device 100. The control section 300 and the information processing device 400 are connected so that they can communicate with each other.

The three dimensional shaping device 100 is equipped with a shaping section 110, which generates and ejects a shaping material, a shaping stage 210, which serves as a base of a shaped object, and a movement mechanism 230, which controls the position where the shaping material is ejected.

The shaping section 110 ejects shaping material, which is plasticized from solid state material, onto the stage 210 under the control of the control section 300. The shaping section 110 includes a material supply section 20, which is the supply source of raw material before it is converted into shaping material, a plasticizing section 30, which converts the raw material into shaping material, and an ejection section 60, which ejects the shaping material.

The material supply section 20 supplies raw material MR to the plasticizing section 30. The material supply section 20 is constituted by, for example, a hopper that accommodates the raw material MR. The material supply section 20 is connected to the plasticizing section 30 via a communication path 22. The raw material MR is supplied to the material supply section 20 in the form of powder or pellets. As the raw material MR, for example, a thermoplastic resin such as an acrylonitrile-butadiene-styrene resin (ABS), a polypropylene resin (PP), a polyethylene resin (PE), or a polyacetal resin (POM) is used.

The plasticizing section 30 plasticizes the raw material MR supplied from the material supply section 20, to generate a paste-like shaping material, which has fluidity, and guides it to the ejection section 60. In the present embodiment, "plasticization" is a concept including melting, and is a change from a solid state to a state having fluidity. Specifically, in the case of a material in which glass transition occurs, plasticization means that the temperature of the material is set to be equal to or higher than the glass transition point. In the case of a material in which glass transition does not occur, plasticization means that the temperature of the material is raised to or higher than the melting point.

The plasticizing section 30 has a screw case 31, a drive motor 32, a flat screw 40, and a barrel 50. The flat screw 40 is also referred to as a rotor or scroll. The barrel 50 is also referred to as a screw facing section.

The flat screw 40 is housed in the screw case 31. An upper surface 47 of the flat screw 40 is connected to the drive motor 32, and the flat screw 40 is rotated in the screw case 31 by a rotational drive force generated by the drive motor 32. The drive motor 32 is driven under the control of the control section 300. The flat screw 40 may be driven by the drive motor 32 via a reduction gear.

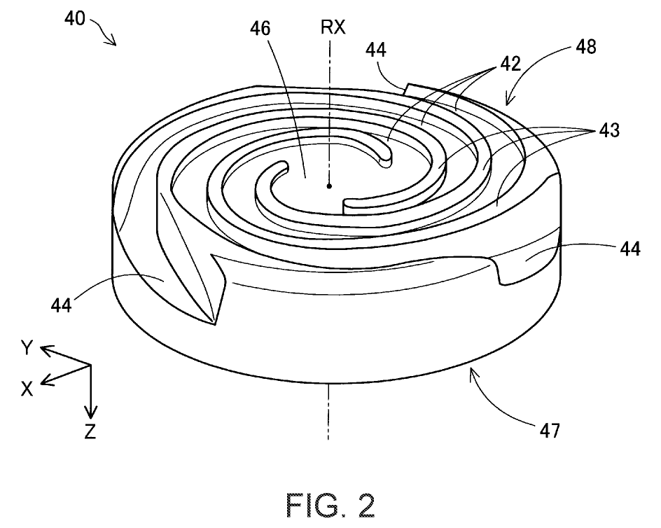

FIG. 2 is a perspective view illustrating a schematic configuration of a lower surface 48 side of the flat screw 40. The flat screw 40 shown in FIG. 2 is illustrated with a positional relationship between the upper surface 47 and the lower surface 48 shown in FIG. 1 reversed in the vertical direction for facilitating understanding of the technology. The flat screw 40 has a substantially cylindrical shape whose length in an axial direction, which is a direction along its central axis, is smaller than a length in directions perpendicular to the axial direction. The flat screw 40 is arranged so that a rotation axis RX, which serves as a rotation center of the flat screw 40, is parallel to the Z direction.

Spiral shaped groove sections 42 are formed on a lower surface 48 of the flat screw 40, which is a surface intersecting the rotation axis RX. The communication path 22 of the material supply section 20 described above communicates with the groove section 42 from the side surface of the flat screw 40. In this embodiment, three groove sections 42, which are spaced apart, are formed by ridge sections 43. Note that the number of groove sections 42 is not limited to three, and may be one or two or more. The groove sections 42 are not limited to a spiral shape, and may be a helix shape or an involute curve shape, or may be a shape extending from the central section 46 toward the outer periphery so as to draw an arc.

As illustrated in FIG. 1, the lower surface 48 of the flat screw 40 faces the upper surface 52 of the barrel 50, and a space is formed between the groove section 42 of the lower surface 48 of the flat screw 40 and the upper surface 52 of the barrel 50. The raw material MR is supplied into this space between the flat screw 40 and the barrel 50 from the material supply section 20 through the material inflow port 44 shown in FIG. 2.

The barrel heater 58 is embedded in the barrel 50 to heat the raw material MR fed into the groove sections 42 of the rotating flat screw 40. A communication aperture 56 is provided at the center of the barrel 50.

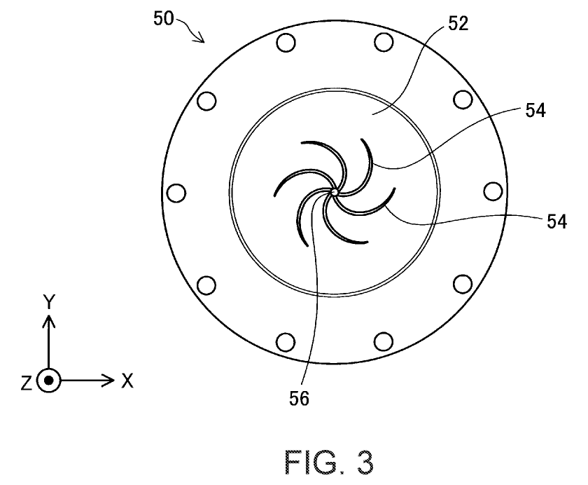

FIG. 3 is a schematic plan view illustrating the upper surface 52 of the barrel 50. On the upper surface 52 of the barrel 50, a plurality of guide grooves 54 are formed, which are connected to the communication aperture 56 and which extend in a spiral shape from the communication aperture 56 toward the outer periphery. Note that one end of the guide grooves 54 may not be connected to the communication aperture 56. The guide grooves 54 may be omitted.

The raw material MR supplied into the groove sections 42 of the flat screw 40 flows along the groove sections 42 by rotation of the flat screw 40 while being plasticized in the groove sections 42, and is guided to the central section 46 of the flat screw 40 as the shaping material. The paste-like shaping material that has fluidity and that flowed into the central section 46 is supplied to the ejection section 60 through the communication aperture 56 provided in the center of the barrel 50. Note that in the shaping material, not all types of substances that constitute the shaping material need to be plasticized. The shaping material should be converted into a fluidity state as a whole by plasticizing at least some types of substances that constitute the shaping material.

The ejection section 60 in FIG. 1 has a nozzle 61 that ejects the shaping material, a shaping material flow path 65 provided between the flat screw 40 and a nozzle opening 62, and an ejection control section 77 that controls the ejection of the shaping material.

The nozzle 61 is connected to the communication aperture 56 of the barrel 50 through the flow path 65. The nozzle 61 ejects the shaping material generated in the plasticizing section 30 from the nozzle opening 62, which is the tip end section of the nozzle 61, toward the stage 210.

The ejection control section 77 includes an ejection adjustment section 70 that opens and closes the flow path 65, and a suction section 75 that sucks and temporarily stores the shaping material.

The ejection adjustment section 70 is provided in the flow path 65, and changes the opening degree of the flow path 65 by rotating in the flow path 65. In the present embodiment, the ejection adjustment section 70 is constituted by a valve. The ejection adjustment section 70 is driven by a first drive section 74 under the control of the control section 300. The first drive section 74 is constituted by, for example, a stepping motor. The control section 300 can adjust the flow rate of the shaping material flowing from the plasticizing section 30 to the nozzle 61, that is, the ejection amount of the shaping material ejected from the nozzle 61, by controlling the rotation angle of the ejection adjustment section 70 using the first drive section 74. The ejection adjustment section 70 can adjust the ejection amount of the shaping material and can control the ON and OFF of the outflow of the shaping material.

The suction section 75 is connected between the ejection adjustment section 70 and the nozzle opening 62 in the flow path 65. The suction section 75 temporarily sucks the shaping material from the flow path 65 when ejection of the shaping material from nozzle 61 is stopped, thereby suppressing a tail-dragging phenomenon where the shaping material drips from nozzle opening 62 in a string-like manner. In the present embodiment, the suction section 75 is constituted by a plunger. The suction section 75 is driven by a second drive section 76 under the control of the control section 300. The second drive section 76 is constituted by, for example, a stepping motor and a rack and pinion mechanism that converts the rotational force of the stepping motor into translational movement of the plunger.

The stage 210 is positioned at a position facing the nozzle opening 62 of the nozzle 61. In the first embodiment, the shaping surface 211 of the stage 210, which faces the nozzle opening 62 of the nozzle 61, is arranged to be parallel to the X and Y directions, that is, the horizontal direction. The stage 210 has a stage heater 212 that suppresses rapid cooling of the shaping material ejected onto the stage 210. The stage heater 212 is controlled by the control section 300.

The movement mechanism 230 changes the relative position between the stage 210 and the nozzle 61 under the control of the control section 300. In the present embodiment, the position of the nozzle 61 is fixed, and the movement mechanism 230 moves the stage 210. The movement mechanism 230 is constituted by a three axis positioner that moves the stage 210 in the three axis directions of X, Y, and Z by the driving forces of three motors. In the present specification, unless otherwise specified, movement of the nozzle 61 means that the nozzle 61 or the ejection section 60 is relatively moved with respect to the stage 210.

Note that in another embodiment, instead of the configuration in which the stage 210 is moved by the movement mechanism 230, a configuration may be adopted in which the position of the stage 210 is fixed and the movement mechanism 230 moves the nozzle 61 with respect to the stage 210. A configuration in which the stage 210 is moved in the Z direction by the movement mechanism 230 and the nozzle 61 is moved in the X and Y directions, or a configuration in which the stage 210 is moved in the X and Y directions by the movement mechanism 230 and the nozzle 61 is moved in the Z direction may be adopted. These configurations can also change the relative positional relationship between the nozzle 61 and the stage 210.

Although only one shaping section 110 is illustrated in FIG. 1, the three dimensional shaping device 100 may be equipped with a plurality of shaping sections 110. By providing a plurality of shaping sections 110, different types of shaping materials can be ejected from each shaping section 110. For example, it is possible to shape the main body of the shaped object and the support structure, which supports the shaped object, with different types of shaping materials.

The control section 300 is a control device that controls the operation of the entire three dimensional shaping device 100. The control section 300 is configured with a computer with one or more processors 310, a storage device 320 consisting of a main storage device and an auxiliary storage device, and an input and output interface for input and output of signals to and from the outside. By executing a program stored in the storage device 320, the processor 310 controls the shaping section 110 and the movement mechanism 230 to shape the shaped object on the stage 210 according to the shaping data obtained from the information processing device 400. Note that the control section 300 may be realized by a combination of circuits instead of being composed by a computer.

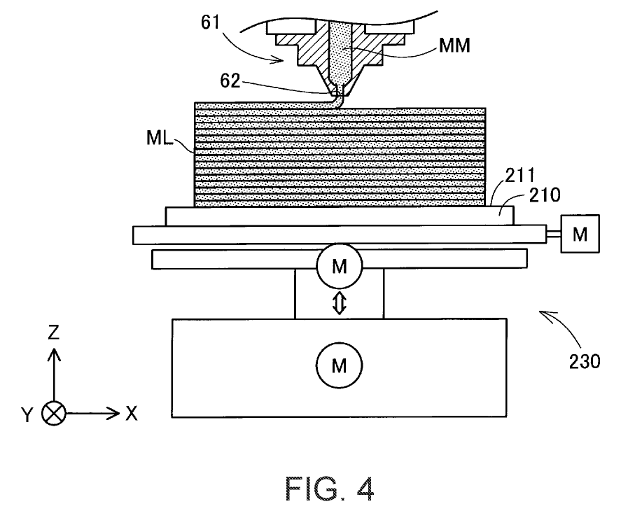

FIG. 4 is an explanatory view schematically illustrating how the three dimensional shaping device 100 shapes the shaped object. In the three dimensional shaping device 100, as described above, the shaping material MM is generated by plasticizing the solid raw material MR. The control section 300 maintains the distance between the shaping surface 211 of the stage 210 and the nozzle 61, and ejects shaping material MM from the nozzle 61 in the direction along the shaping surface 211 of the stage 210 while changing the position of the nozzle 61 with respect to the stage 210. The shaping material MM ejected from the nozzle 61 is continuously deposited in the movement direction of the nozzle 61.

The control section 300 forms layers ML by repeating the movement of the nozzle 61. After forming one layer ML, the control section 300 relatively moves the position of the nozzle 61 with respect to the stage 210 in the Z direction, which is the stacking direction of the layers ML. Then, by further stacking layers ML on the layers ML formed so far, the shaped object is shaped.

The control section 300 may, for example, temporarily suspend ejecting the shaping material from the nozzle 61 when the nozzle 61 moves in the Z direction after the shaping of one layer ML is completed, or when there are multiple independent shaping regions in a single layer. In this case, the ejection adjustment section 70 closes the flow path 65 to stop the ejection of shaping material MM from the nozzle opening 62, and the suction section 75 temporarily sucks the shaping material inside the nozzle 61. After changing the position of the nozzle 61, the control section 300 resumes the deposition of shaping material MM from the changed position of the nozzle 61 by opening the flow path 65 by the ejection adjustment section 70 while ejecting the shaping material in the suction section 75.

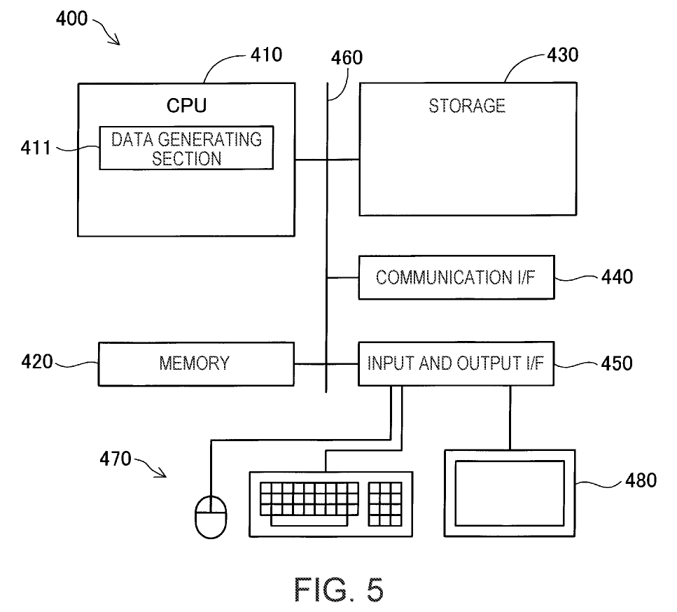

FIG. 5 is an explanatory diagram illustrating schematic configuration of the information processing device 400. The information processing device 400 is configured as a computer in which a CPU 410, a memory 420, a storage device 430, a communication interface 440, and an input and output interface 450 are coupled to each other by a bus 460. An input device 470 such as a keyboard or a mouse and a display section 480 such as a liquid crystal display are coupled to the input and output interface 450. The information processing device 400 is coupled to the control section 300 of the three dimensional shaping device 100 via the communication interface 440.

The CPU 410 functions as a data generating section 411 by executing a program stored in the storage device 430. The data generating section 411 generates shaping data used by the three dimensional shaping device 100 to shape a three dimensional shaped object. The shaping data includes, for each of a plurality of layers obtained by slicing the shape of the model, path information representing a movement path of the nozzle 61 and ejection amount information representing an ejection amount of the shaping material in each movement path. In the present embodiment, the path information includes information representing a line width. Line width means a width of the shaping material ejected along the movement path. The "width of the shaping material" mentioned here means the width in a direction that is orthogonal to the stacking direction and to the extending direction of the movement path. The line width is represented as a width centered on the toolpath of the movement path.

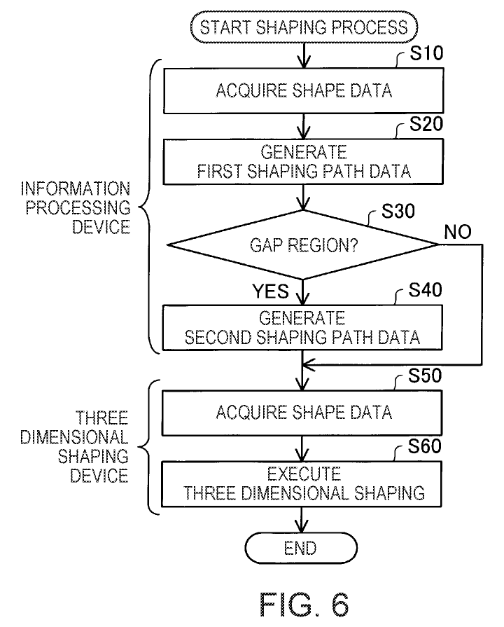

FIG. 6 is a flowchart of a shaping process executed in the three dimensional shaping system 10. The shaping process is a process for realizing a three dimensional shaped object manufacturing method in the present disclosure. The processes from step S10 to step S40 illustrated in FIG. 6 are executed by the information processing device 400, and the processes of step S50 and step S60 are executed by the three dimensional shaping device 100.

In step S10, the data generating section 411 of the information processing device 400 acquires, from another computer, a recording medium, or the storage device 430, the shape data that represents the three dimensional shape of the three dimensional shaped object. The shape data is data representing the shape of the three dimensional shaped object that was generated using a three dimensional CAD software, three dimensional CG software, or the like. As the shape data, for example, data in an STL format, an AMF format, or the like is used. Step S10 is also referred to as a first step.

In step S20, the data generating section 411 generates first shaping path data based on the shape data acquired in step S10. To be more specific, in step S20, the data generating section 411 generates the first shaping path data by analyzing the shape data acquired in step S10 using slicer software. Step S20 is also referred to as a second step.

In step S20, the data generating section 411 generates the first shaping path data according to the first condition. The first condition is a type of path condition. A path condition is a condition related to a movement path. In the present embodiment, the path condition includes a path pattern condition and a line width condition. The path pattern condition defines at least a type of a path pattern. The path pattern is a pattern of a movement path. In the present embodiment, the path pattern condition includes an angle condition that defines an arrangement angle of the path pattern. The line width condition is a condition that defines the line width of the movement path. In the present embodiment, the path pattern in the first condition is a circling pattern. More specifically, the path pattern in the first condition is a circling pattern that circles along the X direction and the Y direction. That is, the movement path generated according to the first condition includes a movement path along the X direction and a movement path along the Y direction.

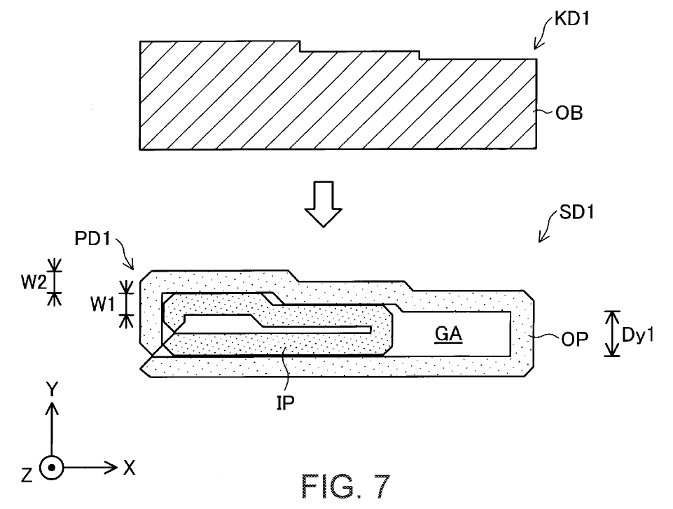

FIG. 7 is a diagram illustrating an example of first shaping path data. In FIG. 7, first shaping path data SD1 is shown as an example of the first shaping path data. The first shaping path data SD1 is based on a first shape data KD1 representing the shape of the three dimensional shaped object OB.

As illustrated in FIG. 7, the first shaping path data SD1 includes first path information PD1 as the path information. The first path information PD1 includes inner path information representing an inner path IP and outer path information representing an outer path OP. The inner path IP is a circling movement path that is located inward from the outer path OP. The outer path OP is a circling movement path that is located outward from the inner path IP. More specifically, the outer path OP circles around so as to encompass around the inner path IP. The line width of the inner path IP is also referred to as a first line width W1. The line width of the outer path OP is also referred to as a second line width W2. In the present embodiment, the first line width W1 and the second line width W2 are the same widths. The first path information PD1 includes information representing the first line width W1 and information representing the second line width W2. The first line width W1 and the second line width W2 in the first path information PD1 are realized based on the line width condition in the first condition.

In the present embodiment, the outer path OP and the inner path IP each correspond to an outer shell path. The outer shell path is a path for shaping an outer shell region representing an outer shell of the three dimensional shaped object OB. The outer shell path is configured as a circling path of one or more times around. In the present embodiment, the outer shell path is constituted by two circling paths, wherein the circling path on the inner side corresponds to the inner path IP and the circling path on the outer side corresponds to the outer path OP. Note that in another embodiment, the outer path OP and the inner path IP may be infill paths. An infill path is a path for shaping an infill region of the three dimensional shaped object OB. An infill region is a region located inward from the outer shell region when viewed in the stacking direction. For example, it may be such that the inner path IP is an infill path and in addition the outer path OP is an outer shell path.

In the example of FIG. 7, the first shaping path data SD1 includes a gap region GA. The gap region GA is a region corresponding to a gap between the inner path IP and the outer path OP. The gap region GA corresponds to a region where the inner path IP cannot be generated according to the first condition. For example, in the example of FIG. 7, since a dimension Dy1 of the gap region GA in the Y direction is less than twice the first line width W1, the inner path IP is not generated in the gap region GA. This is because, in the present embodiment, in order to generate the inner path, which is a circling path along the X direction and the Y direction, in accordance with the angle condition and the path pattern condition included in the first condition, a region is required that has a width of at least twice the first line width W1 in the X direction and in the Y direction.

In step S30 of FIG. 6, the data generating section 411 determines whether or not there is a gap region in the first shaping path data SD1. In step S30, the data generating section 411 determines whether or not there is a gap region based on the inner and outer path difference. The inner and outer path difference is the difference between the length of the inner path IP and the length of the outer path OP. In the present embodiment, the inner and outer path difference represents a difference between the inner peripheral length of the outer path OP and the outer peripheral length of the inner path IP. To be more specific, in step S30, the data generating section 411 determines that there is a gap region GA when the inner peripheral length of the outer path OP is larger than the outer peripheral length of the inner path IP. Step S30 is also referred to as a third step.

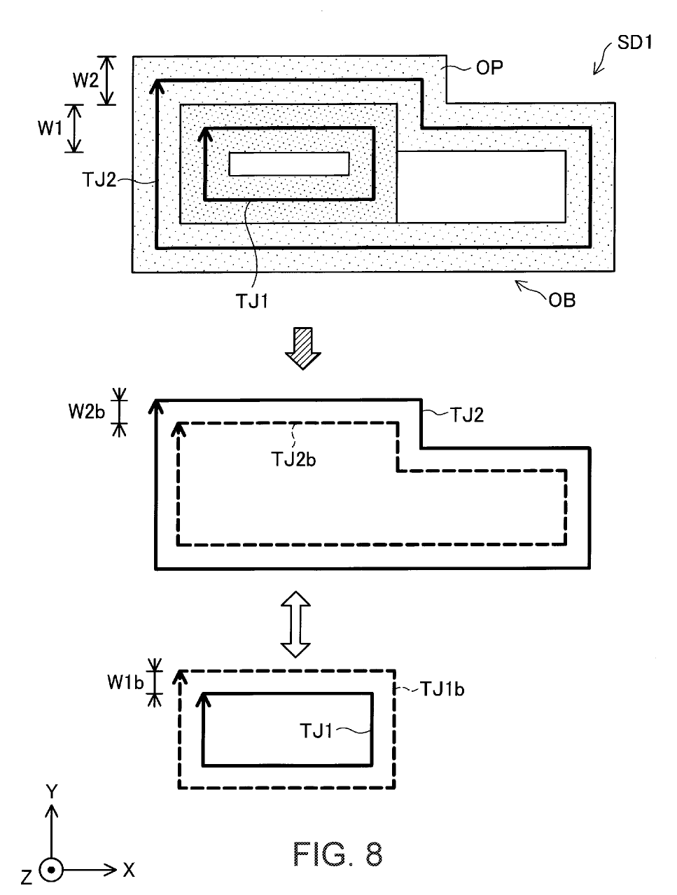

FIG. 8 is a first diagram illustrating an example of the third step in the present embodiment. FIG. 8 shows a toolpath TJ1 of the inner path IP and a toolpath TJ2 of the outer path OP. As illustrated in FIG. 8, in the present embodiment, the data generating section 411 calculates the inner peripheral length of the outer path OP as the length of the toolpath TJ2b obtained by reducing the toolpath TJ2 inward by the amount of the width W2b corresponding to half of the second line width W2. The data generating section 411 calculates the outer peripheral length of the inner path IP as the length of the toolpath TJ1b obtained by expanding the toolpath TJ1 outward by the amount of the width W1b corresponding to half the first line width W1. In the example of FIG. 8, since the length of the toolpath TJ2b is larger than the length of the toolpath TJ1b, that is, since the inner peripheral length of the outer path OP is larger than the outer peripheral length of the inner path IP, it is determined that there is the gap region GA.

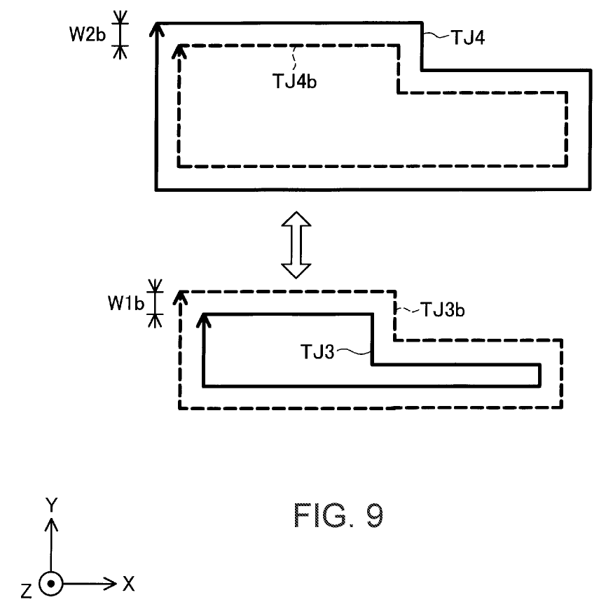

FIG. 9 is a second diagram illustrating an example of the third step in the present embodiment. FIG. 9 illustrates a toolpath TJ3 of an inner path different from the example of FIG. 8 and a toolpath TJ4 of an outer path different from the example of FIG. 8. FIG. 9 illustrates a toolpath TJ4b obtained by reducing the toolpath TJ4 inward by the amount of the width W2b corresponding to half the second line width W2. The data generating section 411 shows a toolpath TJ3b obtained by enlarging the toolpath TJ3 outward by a width W1b corresponding to half the first line width W1. In the example of FIG. 9, since the length of the toolpath TJ4b and the length of the toolpath TJ3b are the same, that is, since the inner peripheral length of the outer path OP and the outer peripheral length of the inner path IP are the same, it is determined that there is no gap region.

When there is a gap region at step S30 in FIG. 6, then at step S40, the data generating section 411 generates second shaping path data according to a second condition. The second condition is a path condition different from the first condition. By executing step S40, shaping data including first shaping path data and second shaping path data is generated. Step S40 is also referred to as a fourth step.

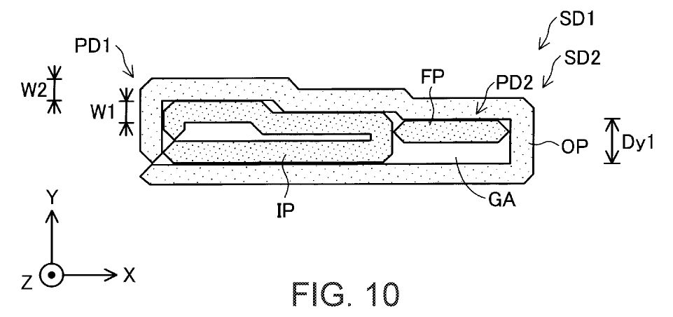

FIG. 10 is a diagram illustrating an example of the second shaping path data. FIG. 10 shows second shaping path data SD2 as an example of the second shaping path data. The second shaping path data SD2 includes second path information PD2 representing a filling path FP. The filling path FP is a movement path for filling the gap region GA.

In the present embodiment, the path pattern condition in the second condition is different from the path pattern condition in the first condition. More specifically, the path pattern represented by the path condition in the second condition is a straight line pattern that does not circle around. Such a linear pattern that does not circle around is also referred to as a "rectilinear pattern". A rectilinear pattern may be constituted by a single straight path extending in the main direction, or by an accordion shaped path reciprocating in the main direction. An accordion shaped path is constituted by a plurality of main paths extending in a main direction and one or more sub paths. The main paths are arranged in an orthogonal direction orthogonal to the main direction. In the present embodiment, the main direction is the X direction. In the present embodiment, the orthogonal direction is the Y direction. The sub paths are movement paths intersecting the main path, and connect, by the shortest distance, ends of main paths that are adjacent to each other in the orthogonal direction. As a result of the path pattern in the second condition being a rectilinear pattern, the path pattern of the filling path FP represented by the second path information PD2 is a rectilinear pattern.

In the present embodiment, the angle of the path pattern in the second condition is defined in advance regardless of the shape of the gap region. That is, the angle condition in the second condition represents an arrangement angle that does not depend on the shape of the gap region. The shape mentioned here includes size. More specifically, in the present embodiment, the angle condition in the second condition represents an arrangement angle that realizes a main path extending in the main direction. That is, in the present embodiment, the main direction is determined by the second condition in advance to be the X direction, regardless of the shape of the gap region.

As illustrated in FIG. 6, when there is no gap region in step S30, step S40 is not executed. In this case, shaping data is generated that includes first shaping path data but does not include second shaping data.

In step S50 of FIG. 6, the control section 300 of the three dimensional shaping device 100 acquires, from the information processing device 400, the shaping data generated in step S30 or step S40. In step S60, the control section 300 controls the ejection section 60 and the movement mechanism 230 according to the shaping data acquired in step S50 to shape a three dimensional shaped object on the shaping surface 211 of the stage 210. That is, the control section 300 shapes the three dimensional shaped object according to the first shaping path data when there is no gap region, and according to the first shaping path data and the second shaping path data when there is a gap region. Step S60 is also referred to as a fifth step.

According to the three dimensional shaped object manufacturing method in the present embodiment described above, whether or not there is a gap region is determined based on the inner and outer path difference between the length of the inner path and the length of the outer path, and when there is a gap region present, second shaping path data that includes second path information representing a filling path for filling the gap region is generated according to the second condition, which is different from the first condition. Therefore, it is possible to determine the presence or absence of a gap region by a simple process of comparing the length of the inner path and the length of the outer path, and in a case where a gap region is present, it is possible to fill the gap region by a simple process of generating second shaping path data under the second condition, which is different from the first condition. By filling the gap region in this manner, it is possible to improve the shaping accuracy and strength of the three dimensional shaped object OB to be shaped.

In the present embodiment, the inner and outer path difference represents a difference between the inner peripheral length of the outer path and the outer peripheral length of the inner path. Therefore, the presence or absence of the gap region can be determined more accurately by a simple process of comparing the inner peripheral length of the outer path and the outer peripheral length of the inner path.

In the present embodiment, the inner peripheral length of the outer path is calculated as the length of a toolpath obtained by reducing the toolpath of the outer path inward by a width corresponding to half the first line width. The outer peripheral length of the inner path is calculated as the length of a toolpath obtained by enlarging the toolpath of the inner path outward by a width corresponding to half the second line width. In the third step, it is determined that there is a gap region when the inner peripheral length of the outer path is larger than the outer peripheral length of the inner path. Therefore, the inner peripheral length of the outer path and the outer peripheral length of the inner path can be more easily calculated regardless of the shape of the three dimensional shaped object, and the inner peripheral length of the outer path and the outer peripheral length of the inner path can be more easily compared.

In the present embodiment, the path pattern in the second condition is different from the path pattern in the first condition. Therefore, when there is a gap region, the gap region can be filled by a simple process of generating second shaping data with a path pattern different from the first shaping path data. In particular, in the present embodiment, the path pattern in the second condition is a rectilinear pattern. Since a rectilinear pattern is a relatively simple path pattern, the gap region can be filled by a simpler process. Furthermore, in the present embodiment, since the angle of the path pattern in the second condition is defined in advance regardless of the shape of the gap region, the gap region can be filled by a simpler process.

### B. SECOND EMBODIMENT

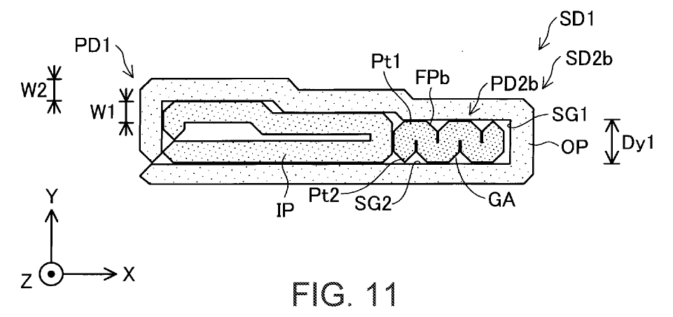

FIG. 11 is a diagram illustrating an example of the second shaping path data in a second embodiment. FIG. 11 shows second shaping path data SD2b as an example of the second shaping path data. The second shaping path data SD2b includes second path information PD2b representing the filling path FPb. In the present embodiment, unlike the first embodiment, the movement path represented by the path pattern in the second condition includes a path Pt1 along a first edge SG1 of the gap region GA and a path Pt2 along a second edge SG2 of the gap region GA. The three dimensional shaping device 100 and the information processing device 400 according to the present embodiment are the same as those in the first embodiment unless otherwise described.

In the present embodiment, the path pattern condition in the second condition represents a rectilinear pattern including a movement path along the edge SG1 and a movement path along the edge SG2. The edge SG1 and the edge SG2 may be any sides that partition the gap region GA as long as the sides extend in different directions. In the present embodiment, the edge SG1 and the path Pt1 are along the Y direction. The edge SG2 and the path Pt2 are along the X direction. In the present embodiment, the angle condition in the second condition is defined as an angle condition that can generate a filling path FPb that has a longer total length. As a result, the gap region GA is filled by an accordion shaped movement path that advances in the X direction while reciprocating in the Y direction as the main direction.

According to the three dimensional shaped object manufacturing method in the second embodiment described above, the movement path represented by the path pattern in the second condition includes the path Pt1 along the first edge SG1 of the gap region GA and the path Pt2 along the second edge SG2. As a result, the filling path FPb can be generated according to the shape of the gap region GA, and thus the possibility that the gap region GA will be filled at a higher density can be increased.

### C. THIRD EMBODIMENT

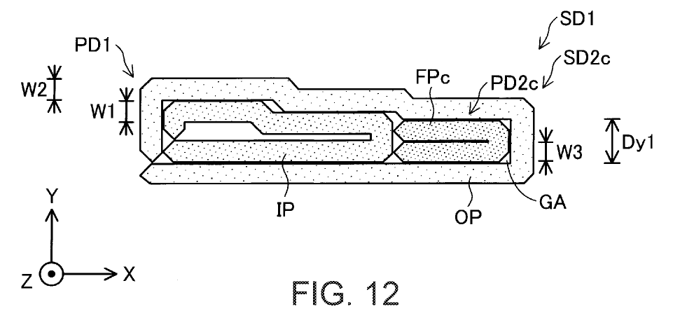

FIG. 12 is a diagram illustrating an example of second shaping path data in a third embodiment. FIG. 12 illustrates second shaping path data SD2c as an example of the second shaping path data. The second shaping path data SD2c includes second path information PD2c representing a filling path FPc. In the present embodiment, unlike the first embodiment, the line width of the filling path FPc under the second condition is smaller than the line width of the inner path IP under the first condition. The three dimensional shaping device 100 and the information processing device 400 according to the present embodiment are the same as those in the first embodiment unless otherwise described.

In the present embodiment, the path pattern under the second condition is a circling pattern similar to the path pattern under the first condition. The line width W3 is less than or equal to half the width of the dimension Dy1. As a result, the filling path FP of the circling pattern is generated in the gap region GA.

According to the three dimensional shaped object manufacturing method in the third embodiment described above, the line width in the second condition is smaller than the line width of the inner path in the first condition. In this way, when there is a gap region, the gap region can be filled by a simple process of generating the second shaping path data with a line width smaller than that of the first shaping path data.

### D. FOURTH EMBODIMENT

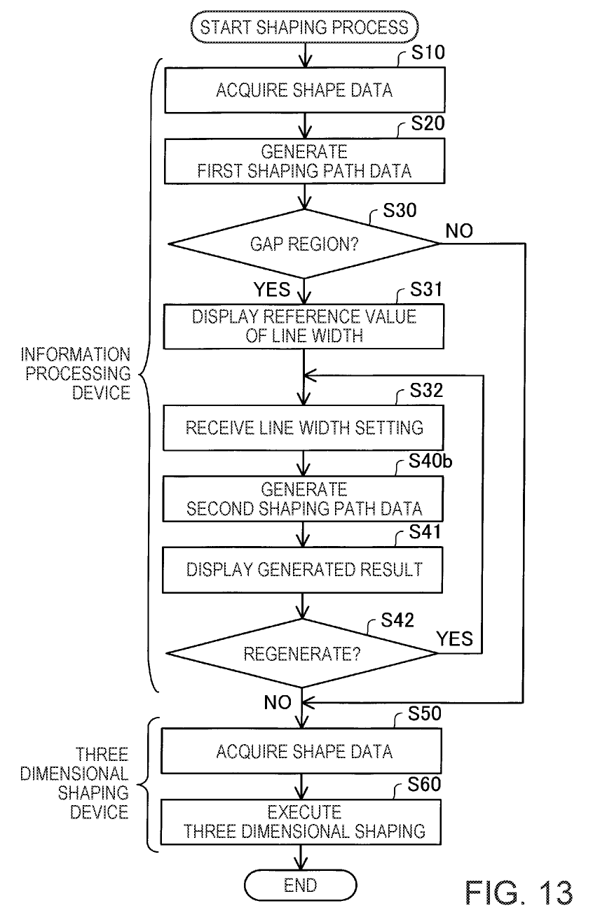

FIG. 13 is a flowchart of the shaping process in a fourth embodiment. As illustrated in FIG. 13, unlike the first embodiment, the shaping process in the present embodiment includes a display process in a step S31. The three dimensional shaping device 100 and the information processing device 400 according to the present embodiment are the same as those according to the third embodiment unless otherwise described.

When there is a gap region at step S30, the data generating section 411 performs a display process at step S31. The display process is a process for displaying, on the display section 480, a reference value of the line width according to the size of the inner and outer path difference. More specifically, the reference value of the line width is set as a desirable line width value of the movement path for filling the gap region. The size of the inner to outer path difference correlates with the size of the gap region. More specifically, the larger the inner and outer path difference, the larger the gap region tends to be. Therefore, by setting the reference value of the line width according to the size of the inner and outer path difference, the reference value of the line width can be set more appropriately.

In step S32, the data generating section 411 receives the setting of the line width from the user, and determines the received line width as the line width in the second condition. In step S32, the user sets the line width by, for example, inputting the line width via the input device 470. In step S32, the user can set the line width in the second condition, for example, in consideration of the reference value of the line width displayed in step S31. In the present embodiment, the second condition is determined by executing step S32 and determining the line width under the second condition in this manner. In the present embodiment, the conditions other than the line width condition in the second condition are the same as the second condition in the third embodiment.

In step S40b, the data generating section 411 generates the second shaping path data in accordance with the second condition determined in step S32.

In step S41, the data generating section 411 displays, on the display section 480, the generated result of the second shaping path data that was generated in step S40b. In step S41, for example, each movement path as illustrated in FIG. 12 is displayed on the display section 480 as an image. The user can, for example, check whether the generated result is appropriate by taking into account the reference value of the line widths generated in step S31 and the generated result displayed in step S41.

In step S42, the data generating section 411 determines whether or not to regenerate the second shaping path data. In step S42, the data generating section 411 determines to regenerate the second shaping path data, for example, when a predetermined input is performed by the user via the input device 470. When it is determined in step S42 that the second shaping path data is to be regenerated, the data generating section 411 returns the process to step S32. In the repeated step S32, the user can set the second condition for regenerating the second shaping path data, for example, in consideration of the reference value of the line width generated in step S31 and the generated result displayed in step S41. When it is determined in step S42 that the second shaping path data is not to be regenerated, shaping data including first shaping path data and second shaping path data at that time is generated. In step S60, a three dimensional shaped object is formed according to the shaping data.

According to the three dimensional shaped object manufacturing method in the fourth embodiment described above, the step of displaying, on the display section 480, the reference value of the line width according to the size of the inner and outer pass difference is provided. Therefore, the user can easily confirm the reference value of the line width corresponding to the size of the gap region.

### E. FIFTH EMBODIMENT

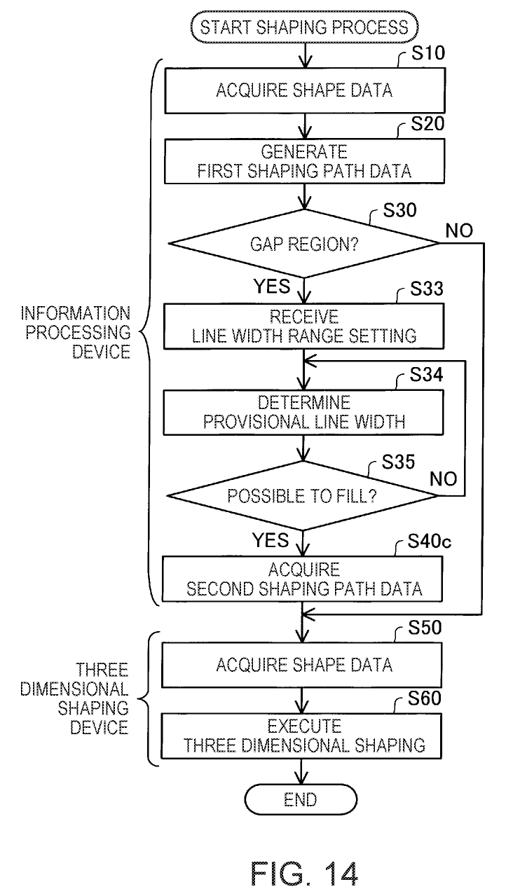

FIG. 14 is a flowchart of a shaping process according to the fifth embodiment. In the present embodiment, unlike the first embodiment, the data generating section 411 executes a line width determination process prior to the fourth step. The line width determination process is a process of determining the line width in the second condition by adjusting the line width of the movement path so that the gap region GA can be filled within a line width range that was set in advance by a user. The three dimensional shaping device 100 and the information processing device 400 according to the present embodiment are the same as those in the first embodiment unless otherwise described.

In step S33, the data generating section 411 receives a setting of a line width range from the user. In step S33, the user sets the line width range by inputting numerical values for setting the line width range via the input device 470, for example. Step S33 may be executed at any timing as long as it is a timing before the line width determination process.

In step S34 and step S35, the data generating section 411 executes the line width determination process. First, in step S34, the data generating section 411 determines a provisional path condition by determining a provisional line width based on the line width setting range received in step S33. The provisional path condition is a path condition different from the first condition. In the present embodiment, the conditions other than the line width condition in the provisional path condition are the same as the second condition in the third embodiment. The provisional line width may be determined at random from a line width range set by the user, for example. The provisional line width may be, for example, determined by designating a line width according to a certain magnification or a certain numerical width from a line width range set by a user.

In step S35, the data generating section 411 verifies whether or not the gap region can be filled according to the provisional path condition determined in step S34. To be more specific, in step S35, the data generating section 411 verifies whether or not the gap region can be filled by generating provisional shaping path data in accordance with the provisional path condition, and determining whether or not the filling path is included in the provisional shaping path data.

When it is determined that the region to be filled cannot be filled in step S35, the data generating section 411 returns the process to step S34. When performing step S34 again, the line widths selected previously may be excluded from the selection target as the provisional line widths. When it is determined in step S35 that the region to be filled can be filled, then in step S40c, the data generating section 411 acquires the second shaping path data by determining the provisional path condition determined in step S34 as the second condition, and generating the second shaping path data according to the determined second condition. That is, in the present embodiment, the determination of the provisional path condition in step S34 and the verification using the provisional shaping data in step S35 are executed until the line widths in the second condition are determined. Note that in another embodiment, in step S40c, the data generating section 411 may acquire, for example, provisional shaping path data that was generated in step S35 as the second shaping path data.

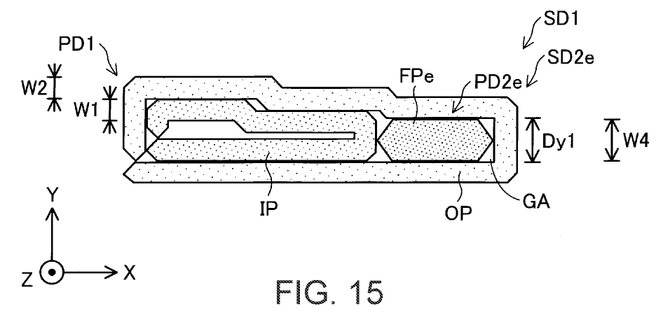

FIG. 15 is a diagram for explaining an example of second shaping path data in the fifth embodiment. FIG. 15 illustrates second shaping path data SD2e as an example of the second shaping path data. The second shaping path data SD2e includes second path information PD2e representing a filling path FPe. In the example of FIG. 15, the filling path FPe has a line width W4 that is larger than the first line width W1 and that is equal to or smaller than the dimension Dy1. The line width W4 corresponds to the line width determined by the above-described line width determination process. In this way, in the present embodiment, the line width W4 of the filling path may be larger than the first line width W1. Such a line width W4 may be determined by setting a line width range in step S33 that includes line widths greater than the first line width W1. In the example of FIG. 15, the gap region GA can be filled with the filling material at a higher density than in the case where the filling path has the first line width W1.

According to the three dimensional shaped object manufacturing method in the fifth embodiment described above, the step of determining the line width in the second condition by adjusting the line width so as to be able to fill the gap region within the line width range that was set in advance by the user is provided prior to the fourth step. Therefore, the gap region can be filled while adjusting the line width of the filling path within a range desired by the user.

### F. OTHER EMBODIMENTS

(F-1) In each of the above embodiments, the inner and outer path difference represents the difference between the inner peripheral length of the outer path and the outer peripheral length of the inner path, but the present disclosure is not limited to this. For example, the inner and outer path difference may be expressed as a difference between a length of a toolpath of the outer path and a length of a toolpath of the inner path.

(F-2) In each of the above embodiments, it is determined that there is a gap region when the inner peripheral length of the outer path is larger than the outer peripheral length of the inner path, but the present disclosure is not limited to this. For example, it may be determined that there is a gap region when the difference between the inner peripheral length of the outer path and the outer peripheral length of the inner path is outside a predetermined reference range.

(F-3) In each of the above embodiments, the inner peripheral length of the outer path is calculated as the length of the toolpath TJ2b, and the outer peripheral length of the inner path is calculated as the length of the toolpath TJ1b, but the inner peripheral length and the outer peripheral length may be calculated by other methods.

(F-4) In each of the above embodiments, the pattern condition in the second condition may represent a path pattern different from a rectilinear pattern or a circling pattern. More specifically, the pattern condition in the second condition may be, for example, a non-circling curved pattern or a non-circling path pattern in which one or more straight lines and one or more curved lines are combined.

(F-5) In the first embodiment, the angle of the path pattern in the second condition is defined in advance regardless of the shape of the gap region, but the present disclosure is not limited to this. For example, the angle of the path pattern in the second condition may be determined according to the shape of the gap region. In this case, the angle of the path pattern in the second condition may be determined according to the direction of the edge that defines the gap region as in the second embodiment. For example, the gap region may be approximated by a bounding box, and the angle of the path pattern in the second condition may be determined such that the movement path is formed along the longitudinal direction of the bounding box. For example, the angle of the path pattern in the second condition may be determined such that a movement path is formed along the longitudinal direction of the three dimensional shaped object to be shaped.

### G. Other aspects

The present disclosure is not limited to the embodiments described above, but can be realized in various aspects without departing from the scope of the present disclosure. For example, the present disclosure can be realized by the following aspects. The technical features in the above embodiments that correspond to the technical features in each aspect described below can be replaced or combined as appropriate to solve some or all of the issues of this disclosure or to achieve some or all of the effects of this disclosure. If the technical features are not described as essential in the present specification, they can be deleted as appropriate.

(1) According to an aspect of the present disclosure, there is provided a three dimensional shaped object manufacturing method of manufacturing a three dimensional shaped object by ejecting a shaping material from an ejection section toward a stage to stack layers. This manufacturing method includes a first step of acquiring shape data representing a three dimensional shape of a three dimensional shaped object; a second step of generating, based on the acquired shape data, first shaping path data including first path information that represents a movement path along which an ejection section moves, the first shaping path data being generated according to a first condition regarding the movement path; a third step of determining whether or not a gap region is present in the first shaping path data; when the gap region is present, a fourth step of generating second shaping path data including second path information representing a movement path for filling the gap region, the second shaping path data being generated according to a second condition, which is different from the first condition; and a fifth step of shaping the three dimensional shaped object according to the first shaping path data when the gap region is not present and according to the first shaping path data and the second shaping path data when the gap region is present. The first path information includes information representing an inner path, which is a movement path that circles around, and information representing an outer path, which is a movement path that circles around and which is located outward from the inner path and in the third step, the presence or absence of the gap region is determined based on a difference between a length of the inner path and a length of the outer path.

According to this aspect, it is possible to determine the presence or absence of the gap region by a simple process of comparing the length of the inner path and the length of the outer path, and in a case where the gap region is present, it is possible to fill the gap region by a simple process of generating the second shaping path data under the second condition, which is different from the first condition.

(2) The above-described aspect may be such that the first path information includes information representing a first line width that is a line width of the inner path and information representing a second line width that is a line width of the outer path and the difference represents a difference between an inner peripheral length of the outer path and an outer peripheral length of the inner path. According to this aspect, it is possible to determine the presence or absence of the gap region with higher accuracy by a simple process of comparing the inner peripheral length of the outer path and the outer peripheral length of the inner path.

(3) The above-described aspects, may be such that the inner peripheral length is calculated as a length of a toolpath obtained by reducing a toolpath of the outer path inward by a width corresponding to half of the second line width, the outer peripheral length is calculated as a length of a toolpath obtained by enlarging a toolpath of the inner path outward by a width corresponding to half of the first line width, and in the third step, a gap region is determined to be present when the inner peripheral length is larger than the outer peripheral length. According to this aspect, the inner peripheral length of the outer path and the outer peripheral length of the inner path can be more easily calculated regardless of the shape of the three dimensional shaped object, and the inner peripheral length of the outer path and the outer peripheral length of the inner path can be more easily compared.

(4) The above-described aspects may be such that a path pattern of the movement path in the second condition is different from the path pattern in the first condition. According to this aspect, when there is a gap region, the gap region can be filled by a simple process of generating the second shaping path data with a path pattern different from that of the first shaping path data.

(5) The above-described aspects may be such that the path pattern in the second condition is a linear pattern that does not circle around. According to this aspect, the gap region can be filled by a simpler process.

(6) The above-described aspects may be such that an angle of the path pattern in the second condition is defined in advance regardless of a shape of the gap region. According to this aspect, the gap region can be filled by an even simpler process.

(7) The above-described aspects may be such that the movement path represented by the path pattern in the second condition includes a path along a first edge of the gap region and a path along a second edge of the gap region. According to this aspect, since the path for filling the gap region can be generated according to the shape of the gap region, it is possible to increase the possibility that the gap region is filled with a higher density.

(8) The above-described aspects may be such that a line width of the movement path in the second condition is smaller than a line width of the inner path in the first condition. According to this aspect, the gap region can be filled by a simple process of generating the second shaping path data with a line width smaller than that of the first shaping path data.

(9) The above-described aspects may further include a step of displaying, on a display section, a reference value of a line width corresponding to a size of the difference. According to this aspect, the user can easily confirm the reference value of the line width corresponding to the size of the gap region.

(10) The above-described aspects may further include a step performed prior to the fourth step, of determining a line width of the movement path under the second condition by adjusting, within a range set in advance by a user, the line width of the movement path so as to enable the gap region to be filled. According to this aspect, the gap region can be filled while adjusting the line width of the movement path for filling the gap region within a range desired by the user.

The present disclosure is not limited to the three dimensional shaped object manufacturing method described above, and can be realized by various aspects such as a three dimensional shaping system, an information processing device, a computer program, and a non-transitory tangible recording medium in which the computer program is recorded so as to be readable by a computer.

What is claimed is:

1. A three dimensional shaped object manufacturing method comprising:
a first step of acquiring shape data representing a three dimensional shape of a three dimensional shaped object;
a second step of generating, based on the acquired shape data, first shaping path data including first path information that represents a movement path along which an ejection section moves, the first shaping path data being generated according to a first condition regarding the movement path;
a third step of determining whether or not a gap region is present in the first shaping path data;
when the gap region is present, a fourth step of generating second shaping path data including second path information representing a movement path for filling the gap region, the second shaping path data being generated according to a second condition, which is different from the first condition; and
a fifth step of shaping the three dimensional shaped object by ejecting the shaping material from the ejection section toward a stage and stacking layers according to the first shaping path data when the gap region is not present and according to the first shaping path data and the second shaping path data when the gap region is present, wherein
the first path information includes information representing an inner path, which is a movement path that circles around, and information representing an outer path, which is a movement path that circles around and which is located outward from the inner path and
in the third step, the presence or absence of the gap region is determined based on a difference between a length of the inner path and a length of the outer path.

2. The three dimensional shaped object manufacturing method according to claim 1, wherein
the first path information includes information representing a first line width that is a line width of the inner path and information representing a second line width that is a line width of the outer path and
the difference represents a difference between an inner peripheral length of the outer path and an outer peripheral length of the inner path.

3. The three dimensional shaped object manufacturing method according to claim 2, wherein
the inner peripheral length is calculated as a length of a toolpath obtained by reducing a toolpath of the outer path inward by a width corresponding to half of the second line width,
the outer peripheral length is calculated as a length of a toolpath obtained by enlarging a toolpath of the inner path outward by a width corresponding to half of the first line width, and
in the third step, a gap region is determined to be present when the inner peripheral length is larger than the outer peripheral length.

4. The three dimensional shaped object manufacturing method according to claim 1, wherein
a path pattern of the movement path in the second condition is different from the path pattern in the first condition.

5. The three dimensional shaped object manufacturing method according to claim 4, wherein
the path pattern in the second condition is a linear pattern that does not circle around.

6. The three dimensional shaped object manufacturing method according to claim 5, wherein
an angle of the path pattern in the second condition is defined in advance regardless of a shape of the gap region.

7. The three dimensional shaped object manufacturing method according to claim 5, wherein
the movement path represented by the path pattern in the second condition includes a path along a first edge of the gap region and a path along a second edge of the gap region.

8. The three dimensional shaped object manufacturing method according to claim 1, wherein
a line width of the movement path in the second condition is smaller than a line width of the inner path in the first condition.

9. The three dimensional shaped object manufacturing method according to claim 8, further comprising:
a step of displaying, on a display section, a reference value of a line width corresponding to a size of the difference.

10. The three dimensional shaped object manufacturing method according to claim 1, further comprising:
a step performed prior to the fourth step, of determining a line width of the movement path under the second condition by adjusting, within a range set in advance by a user, the line width of the movement path so as to enable the gap region to be filled.
